(19) United States
(12) Patent Application Publication
(10) Pub. No.: US 2006/0057254 A1
(43) Pub. Date: Mar. 16, 2006

(54) Zinc-rich foods having effect of preventing diabetes

(75) Inventors: Yoshitane Kojima, Izumi-city (JP); Yutaka Yoshikawa, Toyonaka-city (JP); Naemi Kajiwara, Takarazuka-city (JP); Hiroko Anzai, Ashiya-city (JP); Hiroshi Taniguchi, Kobe-city (JP)

Correspondence Address: KODA & ANDROLIA, 2029 CENTURY PARK EAST, SUITE 1140, LOS ANGELES, CA, 90067, US

(73) Assignee: Junichi Arita

(21) Appl. No.: 10/538,693

(22) PCT Filed: Oct. 3, 2003
(86) PCT No.: PCT/JP03/12742

§ 371 Date: Jun. 10, 2005

(30) Foreign Application Priority Data
Dec. 10, 2002 (JP) 2002-358036
Sep. 4, 2003 (JP) 2003-312400

(51) Int. Cl. A23L 1/30

(52) U.S. Cl. 426/74

(57) ABSTRACT

Zinc (II) ions (zinc sulfate, zinc acetate and the like) originated in inorganic salts making it difficult for such ions to pass through biological membranes, thus being difficult to be incorporated in a human body. For overcoming such problems, it is necessary to develop food products with a prophylactic effect against diabetes, which contain zinc sources and have a lower toxicity than zinc (II) ions, a good stability and good fat-solubility. The present invention provides food products which have a prophylactic effect against diabetes using specified health foods, nutritional (functional) foods or the like containing natural substances that contain zinc in high concentrations (plants such as papaya, maca and the like, and yeasts such as baker's yeast, brewer's yeast and the like).

### TECHNICAL FIELD

The present invention relates to specified health foods, nutritional (functional) foods and the like containing compounds of natural origin that are contained in natural substances.

### BACKGROUND ART

Several treatment drugs have been developed and used clinically on type II diabetes (insulin non-dependent diabetes) which is caused by stress, obesity, insufficient exercise, aging and the like. However, there is no universally effective drug, and there are also commonly problems in terms of side effects. Furthermore, drugs that prevent diabetes are almost unknown (see Non-patent Reference 1). Since around 1980, zinc (II) ions, which are known to have a low toxicity, have been known to have an insulin-like activity (see Non-patent Reference 2). Zinc (II) complexes of vitamins and the like which are biological substances with a low toxicity, good safety, good fat solubility and an insulin-like activity have been developed as complexes that are more effective than zinc ions, and patent applications have been filed for zinc-containing food products (e.g., see Patent Reference 1).

The following may be cited as prior art information relating to the invention of the present application.
Patent Reference 1: PCT International Publication No. WO 02/060432 A1
Non-patent Reference 1: J. Vidal et al., Dieabetes Care, 23, 360-364 (2000)
Non-patent Reference 2: L. Coulston and P. Dandona, Diabetes, 29, 665-7 (1980)

In recent years, diseases arising from lifestyle habits have become a major social problem, and the development of treatment drugs for diabetes, hypertension, arteriosclerosis and the like have received great attention. However, the development of such treatment drugs requires considerable expenditure. As a result, the burden on patients receiving treatment has increased. Against such a background, improvement of the quality of life (QOL) by providing natural substances containing zinc that are easy on human beings and that can be utilized in daily life at a low cost, is an important task.

### DISCLOSURE OF INVENTION

The present invention provides food products such as specified health foods, nutritional (functional) foods or the like which can prevent lifestyle diseases by using natural substances with a high zinc content which have a lower toxicity than zinc (II) ions, which have good stability and which can be taken over a long period of time.

The zinc sources used in the present invention may be any zinc sources that are suitable for administration to humans or other animals. For instance, mineral salts of zinc, organic zinc complexes and the like may be cited as desirable examples. Examples of mineral salts of zinc include zinc acetate, zinc sulfate, zinc chloride, zinc nitrate and the like.

The food products of the present invention may also include other types of foods, food additives, vitamins and minerals.

In regard to these other foods, food additives, minerals and the like, such products may be products that are ordinarily used in the field of foods and the like, or products that may be developed in the future. However, since the food products of the present invention are foods such as specified health foods, nutritional (functional) foods or the like that intrinsically have a blood sugar lowering effect, the combined use of other foods that interfere with this effect is undesirable.

The form of the food products of the present invention may be powder form, granular, tablet form, capsule form liquid form, gel form or any other form.

### BRIEF DESCRIPTION OF DRAWINGS

FIG. 1 shows the results of a glucose loading test performed following the administration of ordinary feed (shown by ●: control group), mineral yeast-Zn containing feed (shown by ∘) and dry yeast containing feed (shown by ▪) to KK-AY mice for nine (9) weeks.

FIG. 2 shows the HbA_{1c} values measured following the administration of ordinary feed (control), mineral yeast-Zn containing feed and dry yeast containing feed to KK-A^{y} mice for eleven (11) weeks.

FIG. 3 shows the mean ingestion amounts during the administration period following the administration of ordinary feed (control), mineral yeast-Zn containing feed and dry yeast containing feed to KK-A^{y} mice for eleven (11) weeks.

FIG. 4 shows the variation in body weight seen when ordinary feed (shown by ●: control group), Zn/papaya containing feed (shown by ∘) and papaya containing feed (shown by □) were administered.

FIG. 5 shows the variation in blood sugar levels seen when ordinary feed (shown by ●: control group), Zn/papaya containing feed (shown by ∘) and papaya containing feed (shown by □) were administered.

FIG. 6 shows the HbA1c values that were measured following the administration of ordinary feed (control), Zn/papaya containing feed and papaya containing feed for six (6) weeks (at ten (10) weeks of age).

FIG. 7 shows the results of a glucose loading test performed following the administration of ordinary feed (shown by ●: control group), Zn/papaya containing feed (shown by ∘) and papaya containing feed (shown by □) for six (6) weeks (at ten (10) weeks of age).

### BEST MODE FOR CARRYING OUT THE INVENTION

The following embodiments (pharmacological tests) are shown to illustrate the present invention, and it should be noted that the present invention is not limited to the described embodiments.

### Embodiment 1

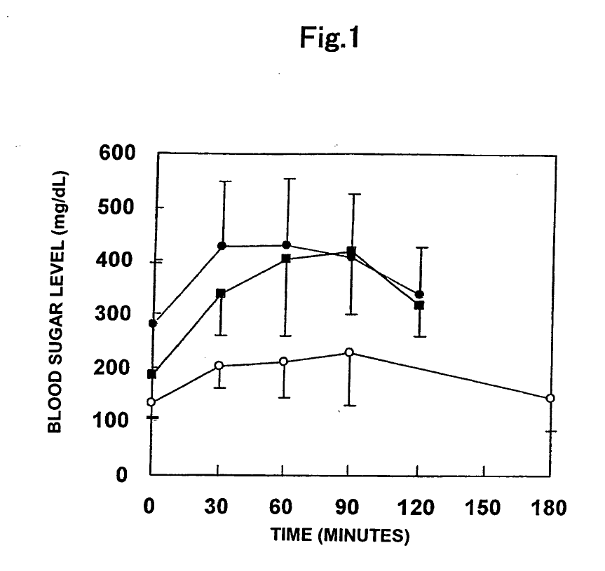

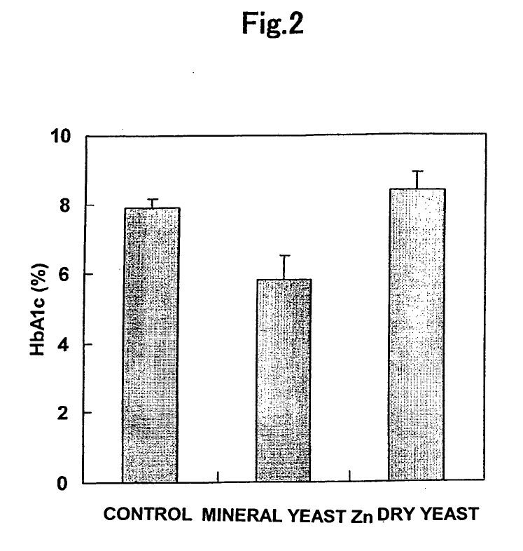

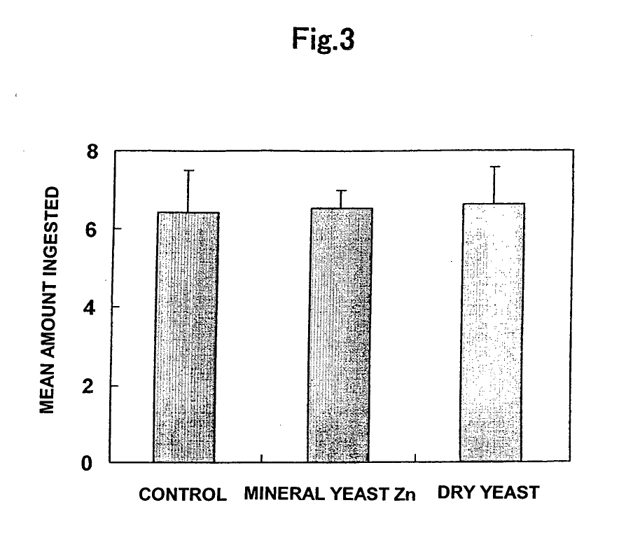

Ordinary feed (shown by ●: control group), high Zn content yeast (e.g., mineral yeast-Zn) feed (shown by ∘) and baker's yeast (e.g., dry yeast) containing feed (shown by ▪) were administered for nine (9) weeks to KK-A^{y} mice (approximately four (4) weeks of age) constituting young type H diabetes model animals not yet showing the onset of type II diabetes; afterward, a glucose loading test (one (1) g glucose/kg of body weight) was performed. HbA_{1c} was measured, and the mean ingestion amount during the administration period was investigated (FIGS. 1, 2 and 3).

As seen from Embodiment 1, the administration group receiving mineral yeast-Zn with a high zinc content showed a clear ameliorating effect in the glucose loading test compared to the control and the administration group receiving only dry yeast. Furthermore, although the ingestion amount showed no change, the HbA_{1c} value also showed an improvement only in the high zinc content mineral yeast-Zn administration group.

### Embodiment 2

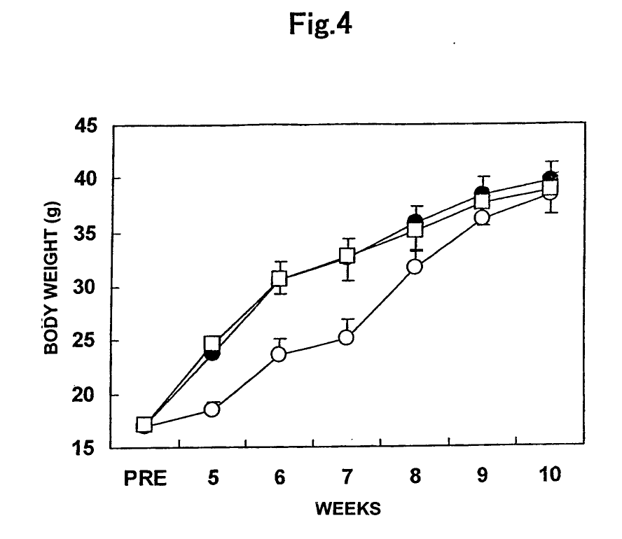

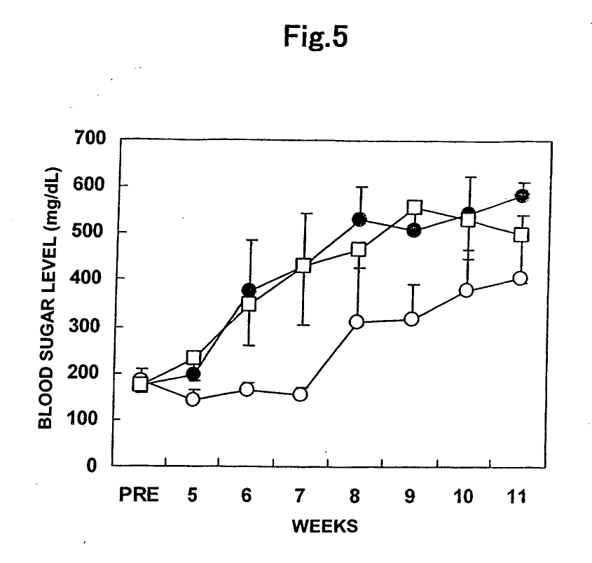

In Embodiment 2, KK-A^{y} mice were purchased at four (4) weeks of age and were allowed to freely ingest ordinary feed, feed prepared by adding papaya with a high zinc content (Zn/papaya) to ordinary feed, or feed prepared by adding papaya (papaya) to ordinary feed until the animals reached eleven (11) weeks of age. The variation in the body weight and variation in blood glucose levels were measured (FIGS. 4 and 5).

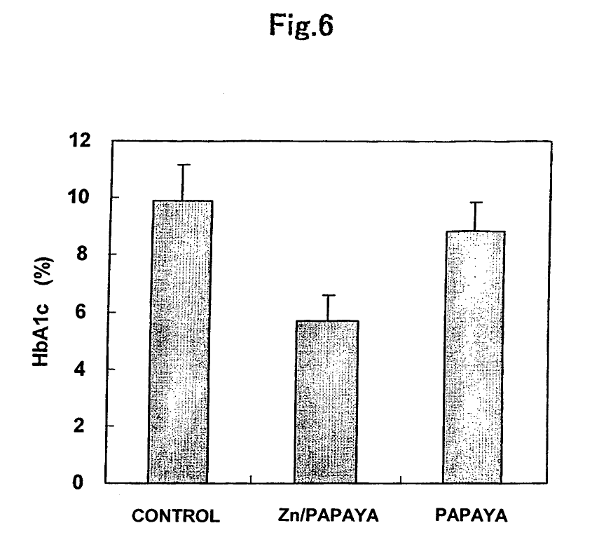

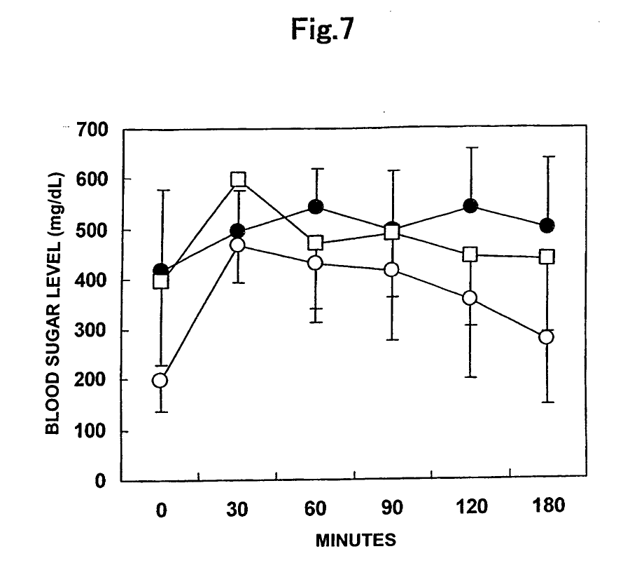

At ten (10) weeks of age, the HbA1c values were measured, and a glucose loading test two (2) g glucose/kg of body weight) was performed using a modified version of the method described in Non-patent Reference 3 (FIGS. 6 and 7).

Non-patent Reference 3: Y. Yoshikawa et al., J. Biol. Inorg. Chem., 7, 68-73 (2002).

As shown in FIG. 4, the group ingesting the Zn/papaya containing feed showed a suppression of the increase in body weight compared to the groups ingesting the other feeds. Since no significant variation in the amount of feed ingested was observed among the three groups, it was indicated that Zn/papaya may have the effect of making the increase in body weight more gradual.

In the group ingesting the feed containing Zn/papaya, as shown in FIG. 5, elevation of the blood sugar levels was suppressed compared to the groups ingesting the other feeds. Thus, it was indicated that Zn/papaya may have the effect of making the elevation of blood sugar levels more gradual and may thus have an effect in delaying the onset of diabetes (i.e., a prophylactic effect against diabetes).

FIG. 6 shows the HbA1c values at ten (10) weeks of age. In the group ingesting the feed containing Zn/papaya, the HbA1c values were low compared to those of the groups ingesting the other feeds, thus indicating a correlation with the data shown in FIG. 5, in which the elevation of blood sugar levels was gradual.

FIG. 7 shows the results of a glucose loading test performed at ten (10) weeks of age. In the group ingesting the feed containing Zn/papaya, the blood sugar levels on an empty stomach (blood sugar levels at a time of 0 minutes) were low compared to those of the other groups, and the recovery of the blood sugar levels elevated following the administration of glucose was also quicker.

The above results indicate that Zn/papaya has the effect of delaying the onset of diabetes and also has an accompanying effect in preventing a deterioration in glucose tolerance. It is clearly indicated that the ingestion of Zn/papaya from an early age is beneficial in preventing diabetes.

### INDUSTRIAL APPLICABILITY

The food products of the present invention which contain zinc sources and natural substances that can interact with zinc consist of natural substances with a high zinc content that have a lower toxicity than zinc (II) ions, a good stability and an effect in lowering blood sugar levels. As a result of this effect in lowering blood sugar levels, hyperlipemia is ameliorated, so that the state of health of diabetes patients, persons in this predisposed group and the like is improved, and so that these food products show great promise as food products such as specified health foods, nutritional (functional) foods or the like which are effect in the prevention and treatment of impaired glucose tolerance, insulin-resistant syndrome (abnormalities in insulin receptors or the like), polycystic ovary syndrome, hyperlipemia, atherosclerosis, cardiovascular disorders, hyperglycemia, angina, hypertension, congestive heart failure, complications of diabetes, impairment of the sense of taste or the like. Furthermore, food and beverage products of the present invention show no substantial side effects even in the case of long-term ingestion and are gentle and safe for humans.

1. A food product containing natural substances (plants such as papaya, maca, ginkgo and the like, and yeasts such as baker's yeast, brewer's yeast and the like) that include zinc at high concentrations.

2. A food product containing zinc sources and foods, said foods being originated in natural substances and contained in plants and/or yeasts and interacting with zinc, said food product having a prophylactic effect against diabetes and maintaining health.

3. The food product according to claim 1 or 2, wherein a mineral source thereof is mineral salts or organic complexes of metals.
